(19) United States
(12) Patent Application Publication
(10) Pub. No.: US 2006/0034583 A1
(43) Pub. Date: Feb. 16, 2006

(54) Media playback device

(75) Inventor: Seiya Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/260,296

(22) Filed: Oct. 28, 2005

Related U.S. Application Data
(63) Continuation of application No. PCT/JP03/08811, filed on Jul. 10, 2003.

(51) Int. Cl. H04N 5/76

(52) U.S. Cl. 386/46; 386/83

(57) ABSTRACT

A media playback device capable of playing back streaming media involving branching playback while preventing a gap from occurring at the switchover of videos, thereby enabling seamless playback. A scheduler schedules one media and other media to be played back continuously or as a branch media after the one media is played back, so as to eliminate a time lag between the playback end time of the one media and the playback start time of the other media. A decoding processor includes a plurality of decoders for performing decoding processes in parallel with each other to decode respective media allotted by the scheduling. A display controller switches the playback outputs from the decoders to display playback media.

This application is a continuing application, filed under 35 U.S.C. § 111(a), of International Application PCT/JP2003/008811, filed Jul. 10, 2003.

### BACKGROUND OF THE INVENTION

1. Field of the Invention

The present invention relates to media playback devices, and more particularly, to a media playback device for playing back streaming media.

2. Description of the Related Art

With the recent explosive increase in traffic capacity of IP networks centered on the Internet, delivery of image/sound data is extensively performed and there is a demand for higher sophistication and wider coverage of such services. Streaming media delivery is one of techniques indispensable to delivery services using networks.

Streaming media is media played back on the time base, such as sound and moving picture. When streaming media is played back by software of a client side, the client side need not hold the entirety of the media and data necessary for momentarily playing back the media has only to be transmitted to the client side. Thus, the client side is capable of playing back data while at the same time receiving a file (the client terminal need not hold a vast amount of data), and this enables the client to watch even a long video, which requires an enormous amount of data, via the Internet.

Exemplary application of streaming media delivery includes interactive drama and e-Learning. Interactive drama is a type of broadcast in which the progress of the drama changes in accordance with instructions from a viewer. For example, each time the viewer gives instructions in the place of the leading character of the drama, the server delivers a video scene complying with the viewer's instructions.

On the other hand, e-Learning is an education system which permits a learner to access the server via a network from a personal computer at home so that the learner can learn by using teaching material content stored in the server. The learner can receive lessons matching his/her learning level without the restrictions on time or place. Also, in accordance with the progress in learning of the learner or the learner's answers to questions, the server delivers a video of teaching material with a different degree of difficulty.

Meanwhile, when a plurality of videos are sequentially streamed and played back via a network in such streaming media delivery, a time interval during which no video is displayed occurs at the switchover of videos. This is because a time lag occurs at the switchover of videos between the end of playback of the preceding video and the start of playback of the succeeding video.

FIG. 26 illustrates a gap occurring at the switchover of videos. As illustrated, a video V1 is played back and its playback ends at time t1. From the time t1 onward, either a video V2-1 or a video V2-2 is played back (branching playback).

The illustrated example corresponds, for example, to the case where the scene of an interactive drama should be changed to the scene of either the video V2-1 or V2-2 at the time t1 in accordance with a scene change instruction given by the client during the progress of the drama of the video V1, or the case where the teaching material of e-Learning should be changed to either one of the videos V2-1 and V2-2 with different degrees of difficulty at the time t1 depending on whether the client's answers to the questions raised in the teaching material of the video V1 are right or wrong.

In such video playback with story branches, when the video V2-1, for example, is played back as a branch following the video V1, the playback of the video V2-1 does not instantly start at the time t1 corresponding to the switchover of the videos but starts at time t2 after a lapse of a time lag, thus causing a gap between t1 and t2. The gap occurs due to the termination and initialization processes of streaming videos.

FIG. 27 explains the reason why such a gap occurs. When the video V2-1 is played back as a branch following the video V1, the receiving-side decoder module performs the termination process for the video V1 and then the initialization process for the video V2-1, and thereafter starts to play back the video V2-1.

Accordingly, when streaming videos are sequentially played back by means of a single decoder module, a time lag Δe+Δs, which is the sum of a time period Δe required for the termination process of the preceding video and a time period As required for the initialization process of the succeeding video, occurs at the switchover of the videos, and during this time interval, no video is displayed.

As conventional techniques for apparent removal of a time lag, a technique has been proposed wherein, when the position for starting repeated playback is specified, a decoder separate from the one currently outputting data is used for the preparation of the repeated playback and then the decoder output is switched (see Japanese Unexamined Patent Publication No. 2001-203977 (paragraph nos. [0016] to [0066], FIG. 1), for example).

There has also been proposed a technique of inserting preload data for playing back the beginning data of files into a preload section prepared for possible branch videos, playing back the corresponding preload data when a branch is determined, and loading the subsequent video data during the playback of the preload data (see Japanese Unexamined Patent Publication No. H07-79399 (paragraph nos. [0006] and [0007], FIG. 1), for example).

With the first-mentioned conventional technique (Japanese Unexamined Patent Publication No. 2001-203977), a plurality of videos to be played back can be concatenated. However, the technique is premised on the condition that the sequence of videos is uniquely determined in advance, and therefore, cannot be applied to services such as interactive drama or e-Learning services in which a branch video to be played back next is not known until a branch-specifying parameter is given.

The second-mentioned conventional technique (Japanese Unexamined Patent Publication No. H07-79399) is based on the assumption that media to be used is a CD-ROM and that the time required to read playback data from a CD-ROM is a cause of the time lag in displaying video. For this reason, small-size preload data corresponding to the initial intervals of possible branch videos are prepared in order to eliminate the time lag, and thus, it cannot be said that the technique is applicable to streaming delivery.

### SUMMARY OF THE INVENTION

The present invention was created in view of the above circumstances, and an object thereof is to provide a media playback device which can prevent a gap from occurring at the switchover of videos and thus can seamlessly play back streaming media involving branching playback.

To achieve the object, there is provided a media playback device for playing back streaming media. The media playback device comprises a scheduler for scheduling one media and other media to be played back continuously or as a branch media after the one media is played back, so as to eliminate a time lag between a playback end time of the one media and a playback start time of the other media, a decoding processor including a plurality of decoders for performing decoding processes in parallel with each other to decode respective media allotted by the scheduling, and a display controller for switching playback outputs from the decoders to display playback media.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 illustrates the principle of a media playback device according to the present invention.

FIG. 2 illustrates streaming video playback wherein a gap is eliminated according to the present invention.

FIG. 3 shows the configuration of a media streaming system.

FIG. 4 also shows the configuration of the media streaming system.

FIG. 5 illustrates a scheduling operation.

FIG. 6 shows the structure of a video source.

FIG. 7 also shows the video source structure.

FIG. 8 shows the structure of a sub-scenario.

FIG. 9 shows the structure of a scenario.

FIG. 10 shows an example of scenario content in XML format.

FIG. 11 exemplifies a sub-scenario.

FIG. 12 exemplifies another sub-scenario.

FIG. 13 exemplifies still another sub-scenario.

FIG. 14 illustrates a video fulfilling three conditional expressions.

FIG. 15 illustrates a condition for selecting a decoder.

FIG. 16 also illustrates the condition for selecting a decoder.

FIG. 17 is a flowchart illustrating a decoder allotment algorithm.

FIG. 18 is a flowchart also illustrating the decoder allotment algorithm.

FIG. 19 shows the configuration of a scenario manager.

FIG. 20 illustrates state transitions of a synchronization controller.

FIG. 21 illustrates a condition under which an initialization process is performed.

FIG. 22 illustrates a condition under which a playback process is performed.

FIG. 23 illustrates a condition under which a termination process is performed.

FIG. 24 illustrates state transitions of a video player.

FIG. 25 illustrates visible/invisible switching of the video player.

FIG. 26 illustrates occurrence of a gap at the switchover of videos.

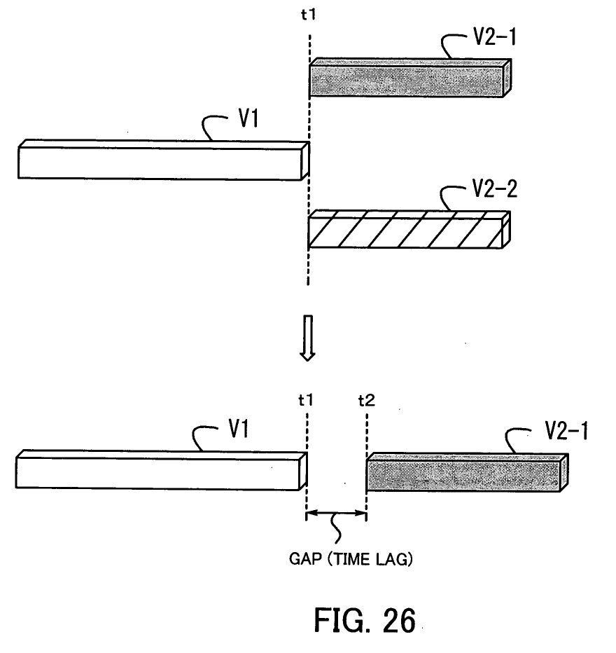

FIG. 27 illustrates the reason why a gap occurs.

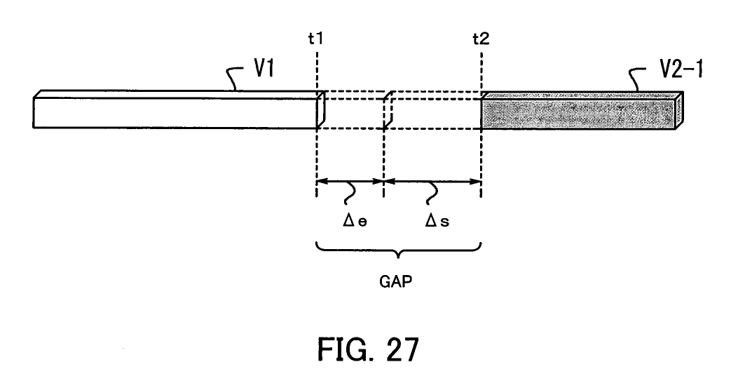

### DESCRIPTION OF THE PREFERRED EMBODIMENTS

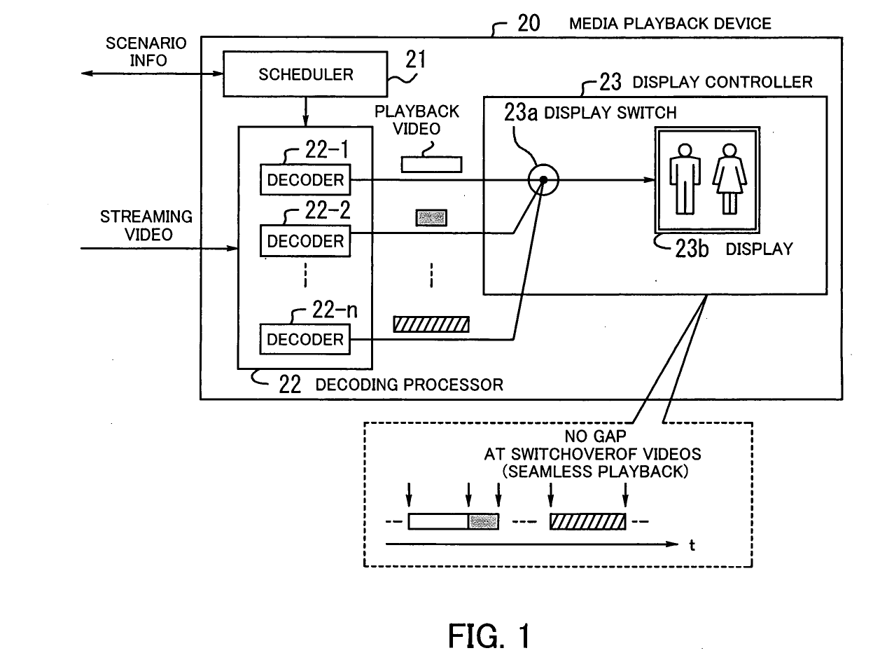

Preferred embodiments of the present invention will be described below with reference to the accompanying drawings. FIG. 1 illustrates the principle of a media playback device according to the present invention. The media playback device 20 is a device for switching a plurality of video sources in accordance with a client's desired operation to play back streaming media. The device is applied, for example, to interactive drama service provided by streaming delivery, or e-Learning service in which the degree of difficulty is varied in accordance with the learner's progress in learning or the learner's answers to questions.

A scheduler 21 schedules one media source (streaming video) and other media source which is to be played back continuously or as a branch media source after the one media source is played back, so as to eliminate a time lag between the playback end time of the one media source and the playback start time of the other media source. Specifically, the scheduler performs the scheduling in accordance with scenario information such that an initialization process of the other media source is completed by the playback end time of the one media source and that the playback of the other media source can be started from the playback end time of the one media source.

A decoding processor 22 includes a plurality of decoders 22-1 to 22-n (referred to as decoder 22 when taken collectively). The decoders 22-1 to 22-n perform decoding processes (each including three processes of initialization, playback and termination) in parallel with each other to decode respective media sources allotted (or assigned, as is used hereinafter) by the scheduling.

The decoding processor 22 includes a streaming buffer, not shown in the figure, and performs the decoding process after a bit stream corresponding to several seconds to several tens of seconds is temporarily stored in the streaming buffer, in order to mitigate instability of data transfer over networks and thereby stabilize playback of videos.

A display controller 23 includes a display switch 23a and a display 23b, and switches playback outputs from the decoders 22-1 to 22-n to display the playback media source. Media source denotes herein a single media, and in the following, media and media source are also referred to as video and video source, respectively.

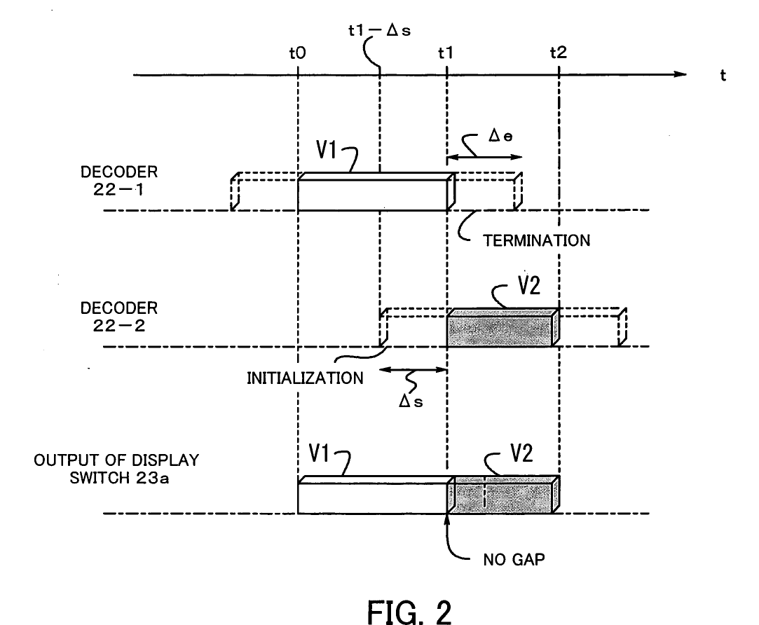

The operation of the device will be now outlined. FIG. 2 illustrates streaming video playback wherein a gap is eliminated according to the present invention. To eliminate a gap during branching playback of videos and thereby attain seamless playback, a plurality of decoders may be prepared to decode videos in parallel with each other.

As a simple example of branching playback, let us suppose the case where video playback is switched from a video V1 to a video V2 at time t1. The videos V1 and V2 are allotted to the decoders 22-1 and 22-2, respectively, to be decoded by the respective decoders.

In this case, if the decoder 22-2 is in a state ready to play back the video V2 when the playback of the video V1 by the decoder 22-1 ends, then it is possible to eliminate a gap which occurs in conventional devices at the branching time t1.

Thus, the scheduler 21 schedules the videos such that at least the initialization process of the video V2 is completed by the playback end time t1 (=branching time) of the video V1 and that the playback of the video V2 can be started from the time t1.

Provided the time period necessary for the initialization process of the video V2 is Δs, the decoder 22-2 starts the initialization process of the video V2 no later than time (t1−Δs) during the playback of the video V1 carried out by the decoder 22-1 from time t0 (i.e., provided the initialization start time of the video V2 is ti, then t0≦ti≦(t1−Δs)). At the time t1, the decoder 22-1 terminates the playback of the video V1 and starts a termination process therefor (the termination process requires a time period Δe) and the decoder 22-2 starts the playback of the video V2 (in the figure, the playback of the video V2 ends at time t2).

In this manner, the videos V1 and V2 are allotted to (scheduled for) the respective decoders 22-1 and 22-2 to be decoded thereby, and the display switch 23a selects the output of the decoder 22-1 from the time t0 to the time t1 and selects the output of the decoder 22-2 from the time t1 to the time t2, whereby the display 23b can display the playback videos seamlessly without a gap.

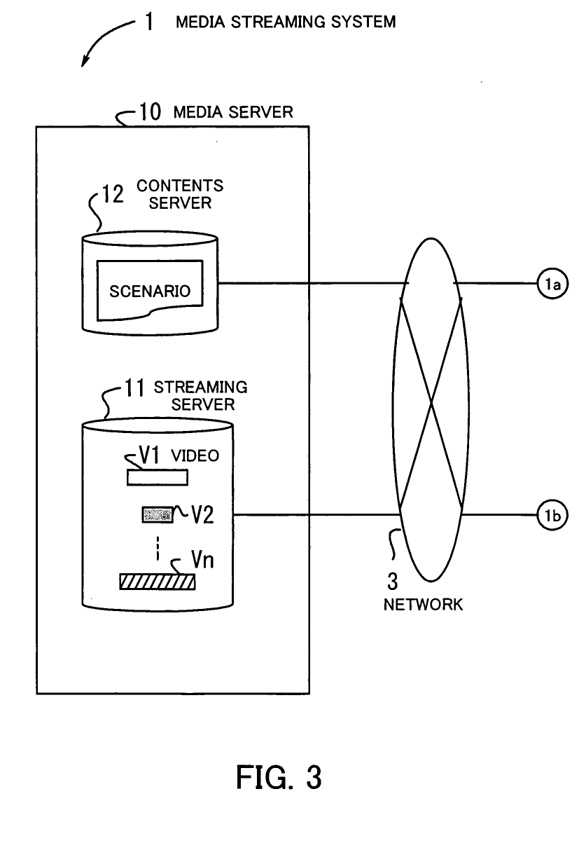

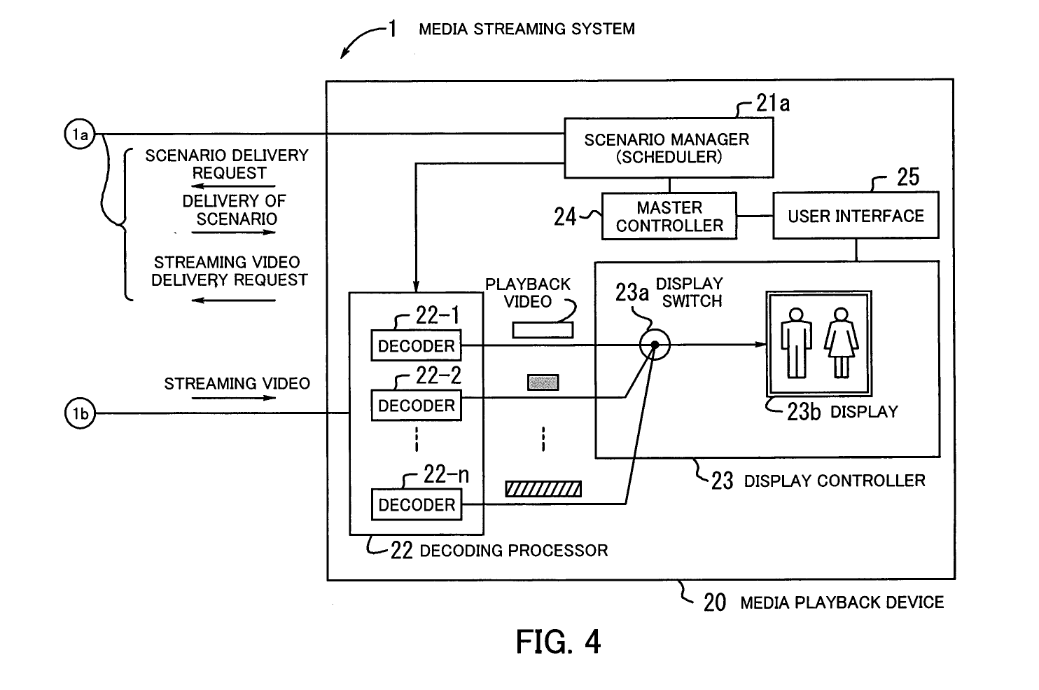

The configuration of an entire system including the media playback device 20 will be now described. FIGS. 3 and 4 show the configuration of a media streaming system. The media streaming system 1 is constituted by a media server 10 shown in FIG. 3 and the media playback device 20 shown in FIG. 4, and delivers streaming media via a network 3.

The media server 10 comprises a streaming server 11 and a contents server 12. The streaming server 11 stores and manages various video contents including the videos V1 to Vn. The streaming server 11 is an ordinary HTTP server corresponding to existing products such as Real Server and Windows Media Server. A plurality of streaming servers are used depending on scenario.

The contents server 12 stores and manages a scenario of the videos V1 to Vn. In the scenario is described the procedure for playing back the video content. For example, the scenario describes such a playback procedure (order of playback, branching conditions, etc.) that after a video A is played back from time ta to time tb, a video B is played back as a branch video from time tc to time td.

The media playback device 20 comprises a scenario manager 21a (corresponding to the scheduler 21), the decoding processor 22, the display controller 23, a master controller 24, and a user interface 25.

The user interface 25 provides a GUI (Graphical User Interface) which enables the client to specify a scenario (enter a URL) to be played back as well as to start, stop, and suspend the playback of the scenario, and corresponds to a keyboard, switches, mouse, etc. Also, the user interface permits the client to set a branching parameter (select a branch screen) through operation of buttons on the screen.

The master controller 24 converts the client's instructions, input via the user interface 25, to operation commands for individual modules. For example, when the URL of a scenario is input, the master controller 24 instructs the scenario manager 21a to read in the scenario.

The scenario manager 21a transmits a scenario delivery request to the contents server 12 and acquires the corresponding scenario stored in the contents server 12. Then, based on the scenario, the scenario manager 21a schedules allotment of the decoders and sends a streaming video delivery request to the streaming server 11.

Also, in response to an external input via the user interface 25, the scenario manager 21a sets a branching parameter, compares the set branching parameter with the branching condition described in the scenario to select a video meeting the condition, and instructs the corresponding decoder to start to play back the video.

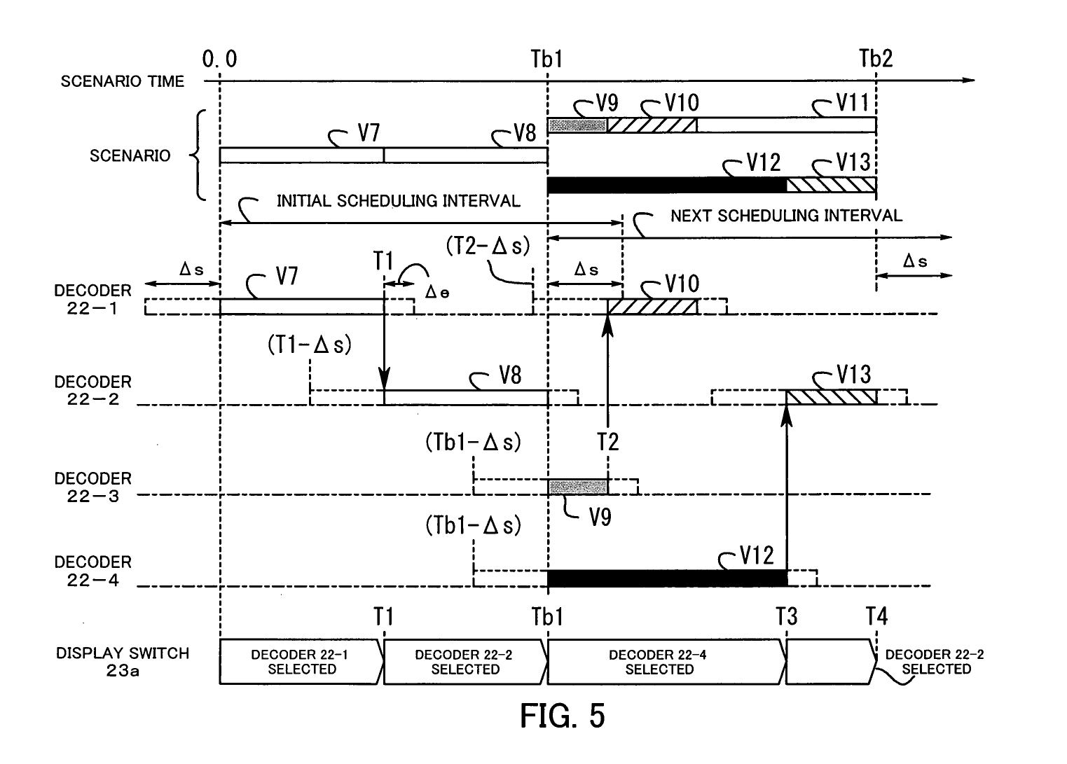

The scheduling operation of the scenario manager 21a will be now described. FIG. 5 illustrates a scheduling operation for a plurality of videos. The scenario illustrated in the figure indicates that after videos V7 and V8 are sequentially played back, a set of videos V9 to V11 or a set of videos V12 and V13 is to be played back as a branch from branching time Tb1, and in the illustrated example, the set of videos V12 and V13 is selected as a branch in accordance with a branching parameter specified by the client.

In the figure, the dotted interval shown to the left of each video playback time indicates the initialization process which requires the time interval Δs with respect to each video. The dotted interval shown to the right of each video playback time indicates the termination process which requires the time interval Δe with respect to each video.

First, the scenario manager 21a allots the decoders 22-1 to 22-4 videos of which the playback is possibly started during a time interval (Tb1+Δs) (in the figure, initial scheduling interval). In the illustrated example, the videos of which the playback is possibly started during the time interval (Tb1+Δs) include not only the videos V7 and V8 but the videos V9, V10 and V12.

The videos are allotted to the decoders 22-1 to 22-4 in the following manner. The videos V7 and V8 are allotted to the decoders 22-1 and 22-2, respectively. Also, the video V9, which is the first video of one set to be branched, is allotted to the decoder 22-3, and the video V12, which is the first video of the other set to be branched, is allotted to the decoder 22-4. Further, the video V10 also is within the initial scheduling interval, and therefore, is allotted to the decoder 22-1 which completes the decoding process earliest.

As for the video decoding start scheduling time, the decoder 22-1 starts to play back the video V7 from time 0.0. The decoder 22-2 starts to decode the video V8 at time (T1−Δs) because the initialization process of the video V8 must be completed by the playback end time T1 of the video V7 so that the video V8 can be played back from the time T1.

The decoder 22-3 starts to decode the video V9 at time (Tb1−Δs) because the initialization process of the video V9 must be completed by the branching time Tb1 so that the video V9 can be played back from the branching time Tb1. Similarly, the decoder 22-4 starts to decode the video V12 at time (Tb1−Δs) because the initialization process of the video V12 must be completed by the branching time Tb1 so that the video V12 can be played back from the branching time Tb1.

Also, the decoder 22-1 starts to decode the video V10 at time (T2−Δs) because the initialization process of the video V10 must be completed by the playback end time T2 of the video V9 so that the video V10 can be played back from the time T2.

On completion of the scheduling for the initial scheduling interval, during the time period before the branching time Tb1, the decoders 22-1 and 22-2 start to decode the videos V7 and V8 at the respective times as scheduled and the decoders 22-3 and 22-4 perform initialization processes for the videos V9 and V12 at the respective times as scheduled.

Let it be assumed that at the branching time Tb1 thereafter, the client selects the set of videos V12 and V13. In this case, the decoder 22-4 starts to play back the video V12 whose initialization process has already been completed. Also, the decoders 22-1 and 22-3, to which the unselected videos V9 and V10 have been allotted, are released.

Then, scheduling is performed again for the next scheduling interval (time (Tb2+Δs)−time Tb1) including the branching time Tb2. In this case, the video V13 is allotted to the decoder 22-2, which then plays back the video.

The display switch 23a selects the output of the decoder 22-1 from the time 0.0 to the time T1, selects the output of the decoder 22-2 from the time T1 to the time Tb1, selects the output of the decoder 22-4 from the time Tb1 to the time T3 (playback end time of the video V12), and selects the output of the decoder 22-2 from the time T3 to the time T4 (playback end time of the video V13).

The scheduling is performed in this manner to switch the decoding and the display, whereby a gap is prevented from occurring at the switchover of playback videos, thus permitting seamless playback and display.

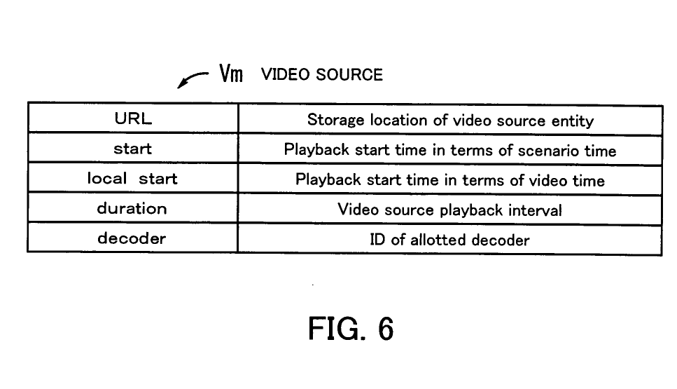

The structure of the scenario stored in the contents server 12 will be now described. FIG. 6 shows the structure of a video source. The video source Vm includes items “URL”, “start”, “local start”, “duration”, and “decoder”. The item “URL” indicates the storage location (address) of the entity of the video source, “start” indicates a playback start time in terms of the scenario time, “local start” indicates a playback start time in terms of video time (video local time), “duration” indicates a playback time interval of the video source, and “decoder” indicates the ID of a decoder allotted.

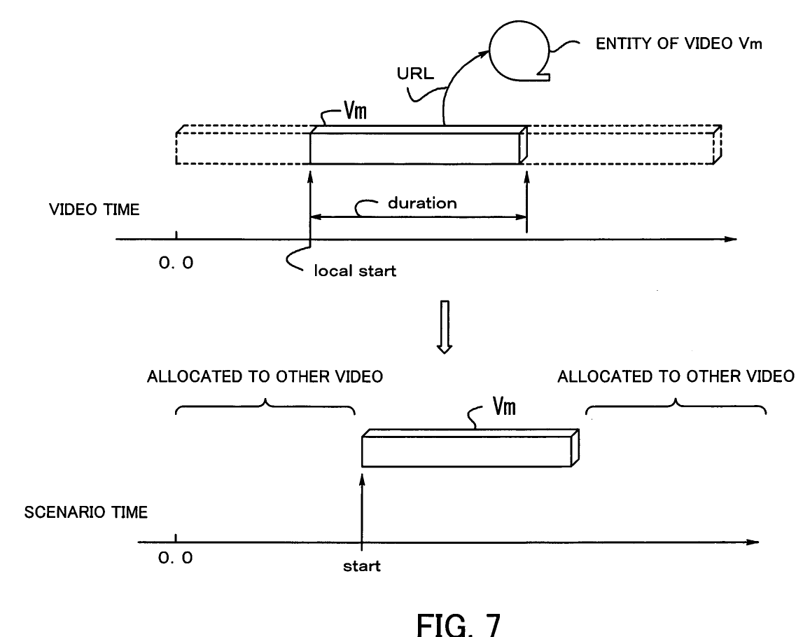

FIG. 7 schematically shows the structure of the video source shown in FIG. 6. The entity of the video source Vm is stored at the address (URL) of the contents server 12. With respect to the playback time (video time) of the video source Vm, “local start” is the playback start time of the video source Vm and “duration” is the playback interval of the video source Vm. Thus, if the video source Vm is a one-hour video and is to be played back only for a section thereof beginning after a lapse of 10 seconds from the start and ending after a lapse of 30 seconds from the start, for example, “local start” is “10 seconds” and “duration” is “20 seconds”. The time at which the video source Vm is actually played back is “start” in terms of the scenario time.

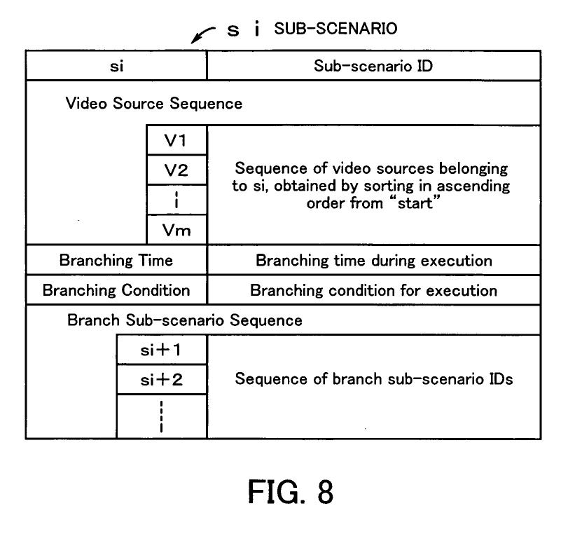

FIG. 8 shows the structure of a sub-scenario. The sub-scenario si includes items “Sub-scenario ID”, “Video Source Sequence”, “Branching Time”, “Branching Condition”, and “Branch Sub-scenario Sequence”. The sub-scenario denotes videos intervening between branching points. In FIG. 5, for example, the videos V7 and V8 correspond to one sub-scenario, the videos V9 to V11 correspond to one sub-scenario, and the videos V12 and V13 correspond to one sub-scenario.

Under the item “Video Source Sequence”, the video sources Vm, explained above with reference to FIGS. 6 and 7, which belong to the same sub-scenario ID are arranged after being sorted in ascending order (in order of playback time) of “start”. For “Branching Time”, the branching time during execution is stored, and for “Branching Condition”, the branching condition for execution is stored. Under the item “Branch Sub-scenario Sequence”, the IDs of sub-scenarios as branches are stored.

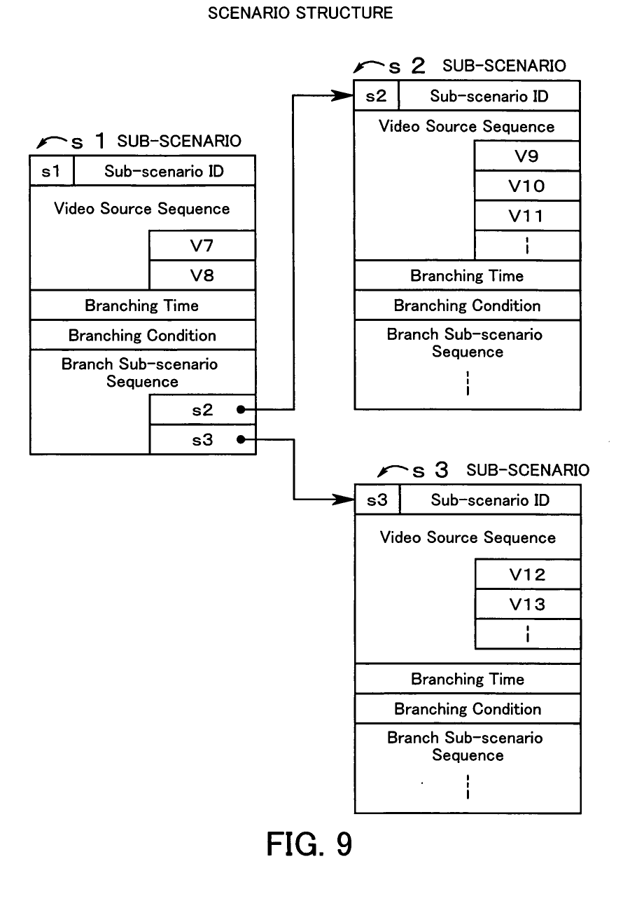

FIG. 9 shows the structure of the scenario corresponding to the one exemplified in FIG. 5. The videos V7 and V8 constitute a sub-scenario s1, the videos V9 to V11 constitute a sub-scenario s2, and the videos V12 and V13 constitute a sub-scenario s3.

In the sub-scenario s1, the video sources V7 and V8 are stored under the item “Video Source Sequence” and the IDs of the sub-scenarios s2 and s3 are stored under the item “Branch Sub-scenario Sequence”. In the sub-scenario s2 as a branch, the video sources V9, V10, V11, . . . are stored under the item “Video Source Sequence”, and in the branch sub-scenario s3, the video sources V12, V13, . . . are stored under the item “Video Source Sequence”.

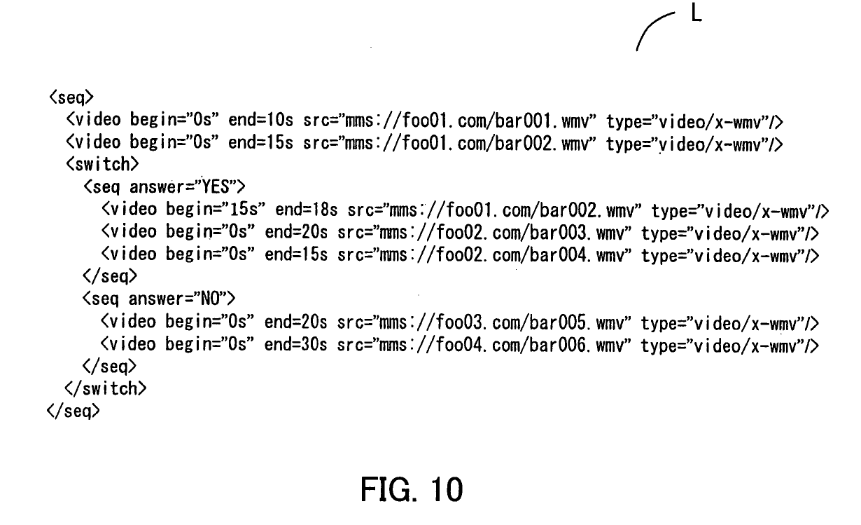

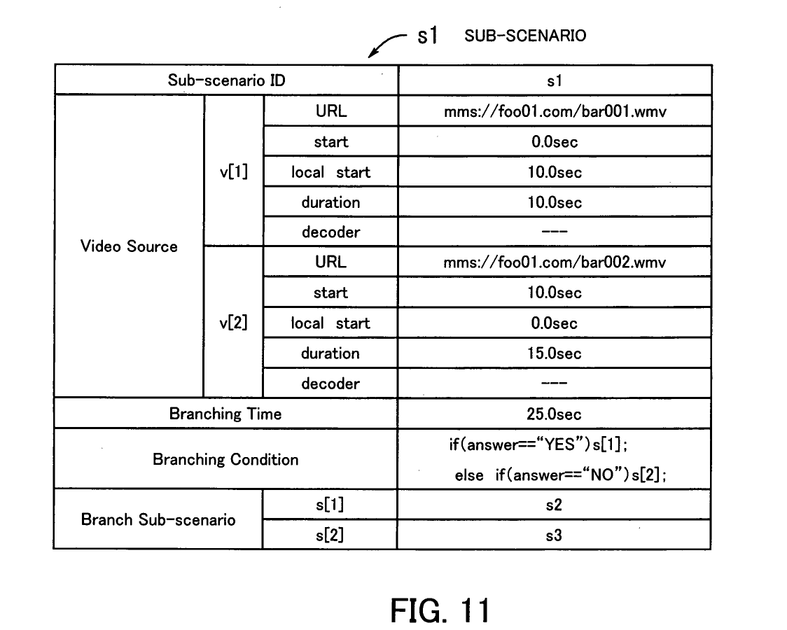

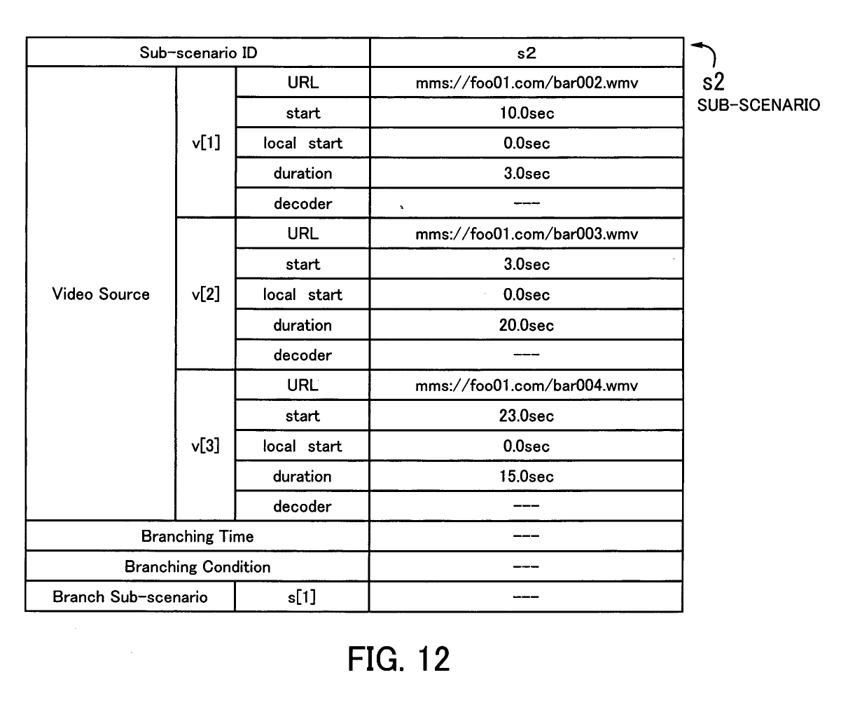

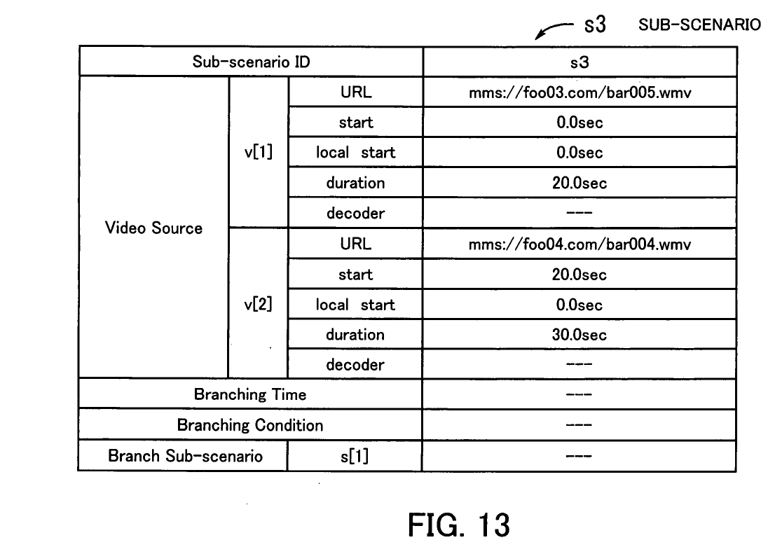

Specific examples of how the scenario and the sub-scenarios are described are illustrated in FIGS. 10 to 13. FIG. 10 shows a list L of scenario content in the format XML (extensible markup language: a simplified language based on SGML and used for defining language specifications of document information etc.), and FIGS. 11 to 13 exemplify the sub-scenarios s1 to s3, respectively.

An algorithm for allotting videos to an identical decoder will be now explained. Here, videos falling within the same scheduling interval (videos to be scheduled) are denoted by V*m. In the example of FIG. 5, five videos, namely, V7 to V10 and V12, fall within the initial scheduling interval, therefore, V*m (m=7 to 10, 12), and the sequence of the videos in order of playback time is: V*7=V7, V*8=V8, V*9=V9, V*12=V12, and V*10=V10.

Let us suppose that the decoding of a video V*ma is allotted to one of the multiple decoders 22-1 to 22-n and that a video to be decoded next is V*mb. In this case, if the playback of the video V*mb continues directly from that of the video V*ma (if neither the termination process of the preceding video nor the initialization process of the succeeding video is required), the video V*mb is desirably allotted to the decoder to which the decoding of the video V*ma is already allotted.

Thus, when allotting the video V*mb to a decoder, first, the relationship of the video V*mb with the already allotted video V*ma is checked to determine whether or not the video V*mb is to be allotted to the same decoder to which the video V*ma has already been allotted. Conditional expressions (1a), (1b) and (1c), indicated below, are used for the determination, and if the three expressions are fulfilled, the video V*mb is allotted to the same decoder to which the video V*ma is already allotted.
V*ma.URL=V*mb.URL (1a)
V*ma.local start+V*ma.duration=V*mb.local start (1b)
V*ma.start+V*ma.duration=V*mb.start (1c)

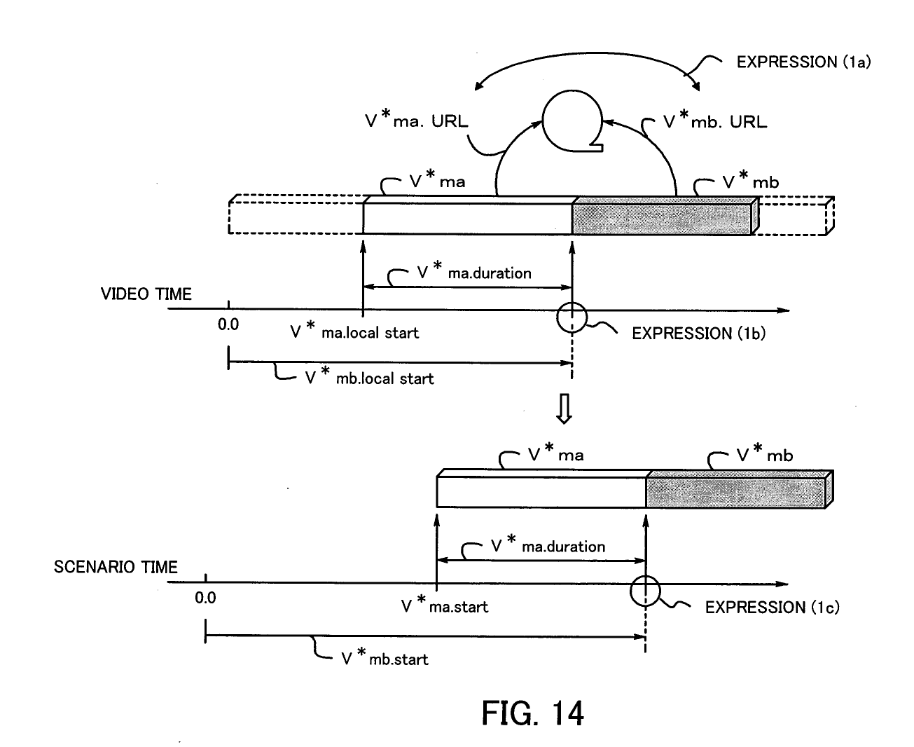

FIG. 14 shows the video V*mb fulfilling the three conditional expressions (1a), (1b) and (1c), wherein the expressions are schematically illustrated. Expression (1a) specifies that the URL of the video V*mb is identical with that of the video V*ma (the entities of these videos are identical). Expression (1b) specifies that, in terms of the video time, the playback end time (=V*ma.local start+V*ma.duration) of the video V*ma coincides with the playback start time (=V*mb.local start) of the video V*mb.

Further, Expression (1c) specifies that, in terms of the scenario time, the playback end time (=V*ma.start+V*ma.duration) of the video V*ma coincides with the playback start time (=V*mb.start) of the video V*mb.

If Expression (1a) is fulfilled, that is, the URLs of the videos V*mb and V*ma are identical with each other, and if Expression (1b) is fulfilled, that is, the end time of the video V*ma and the start time of the video V*mb coincide with each other in terms of the video time, and also if Expression (1c) is fulfilled, that is, the end time of the video V*ma and the start time of the video V*mb coincide with each other in terms of the scenario time, then these two videos can be played back as a continuous section of a single video, and accordingly, the video V*mb is allotted to the same decoder to which the video V*ma is already allotted (as neither the termination process of the video V*ma nor the initialization process of the video V*mb is required).

The following explains how videos are allotted to the decoders in cases where the above conditional expressions are not fulfilled. In the case of allotting the video V*mb after the video V*ma is allotted to a certain decoder, if all of the three conditional Expressions (1a), (1b) and (1c) fail to be fulfilled, a decoder which is idle at the time V*mb.start is selected.

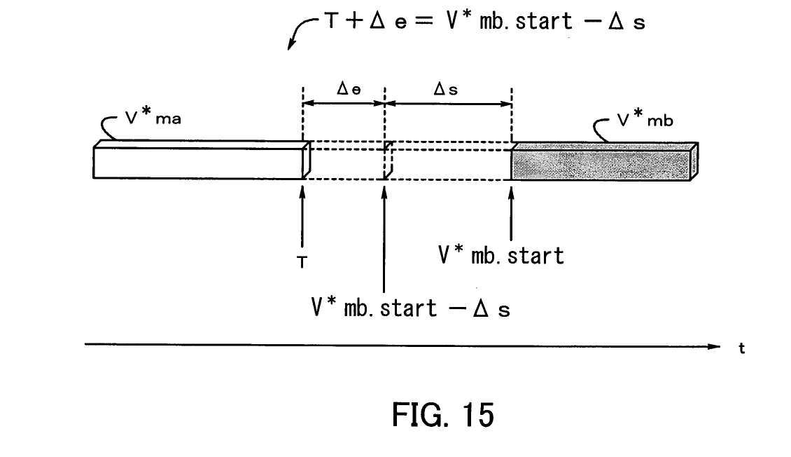

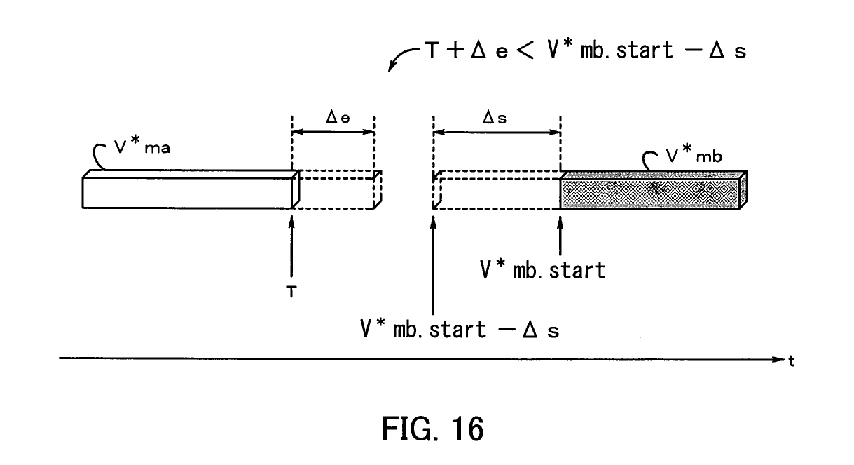

FIGS. 15 and 16 illustrate a condition for selecting a decoder, wherein T is the playback end time of the video V*ma, Δe is the time period required for the termination process of the video V*ma, V*mb.start is the playback start time of the video V*mb, and Δs is the time period required for the initialization process of the video V*mb.

In order for the playback of the video V*mb to be started at the time (V*mb.start−Δs), it is necessary that the playback of the video V*ma be completed by the time T. Thus, the condition for decoders selectable at the time V*mb.start can be expressed by the following expression (2):
(V*mb.start−Δs)≧(T+Δe) (2)

FIGS. 15 and 16 schematically illustrate the case where equality of Expression (2) stands and the case where inequality of the same expression stands, respectively. In Expression (2), the right side (T+Δe) indicates a time at which the corresponding decoder becomes reusable, and the left side (V*mb.start−Δs) indicates an initialization start time limit by which the initialization of the video V*mb needs to be started in order to play back the video from the specified time V*mb.start. If the value of the left side is smaller than that of the right side, then it means that the initialization of the corresponding decoder cannot be completed by V*mb.start, and thus, the video V*mb is not allotted to the decoder.

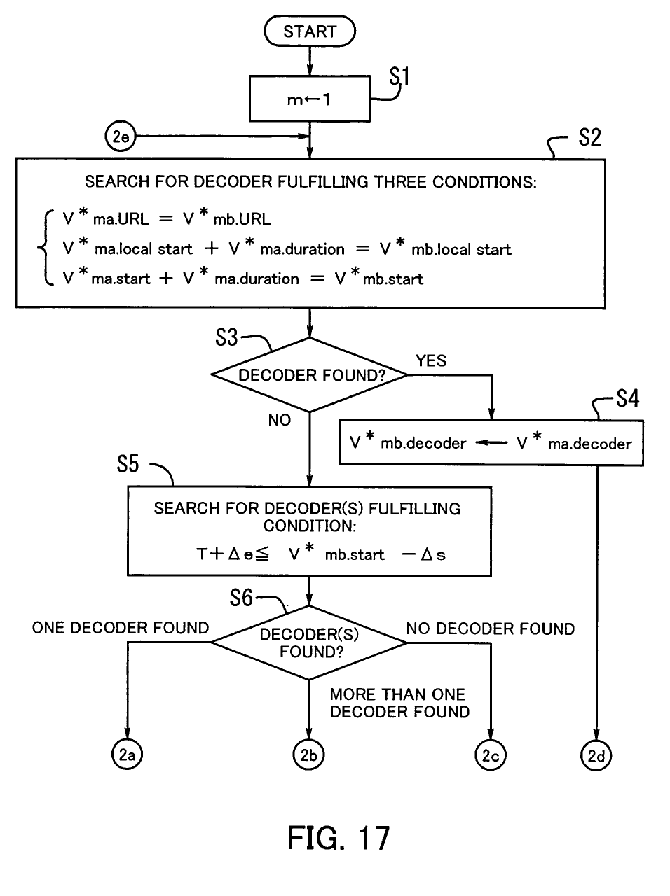

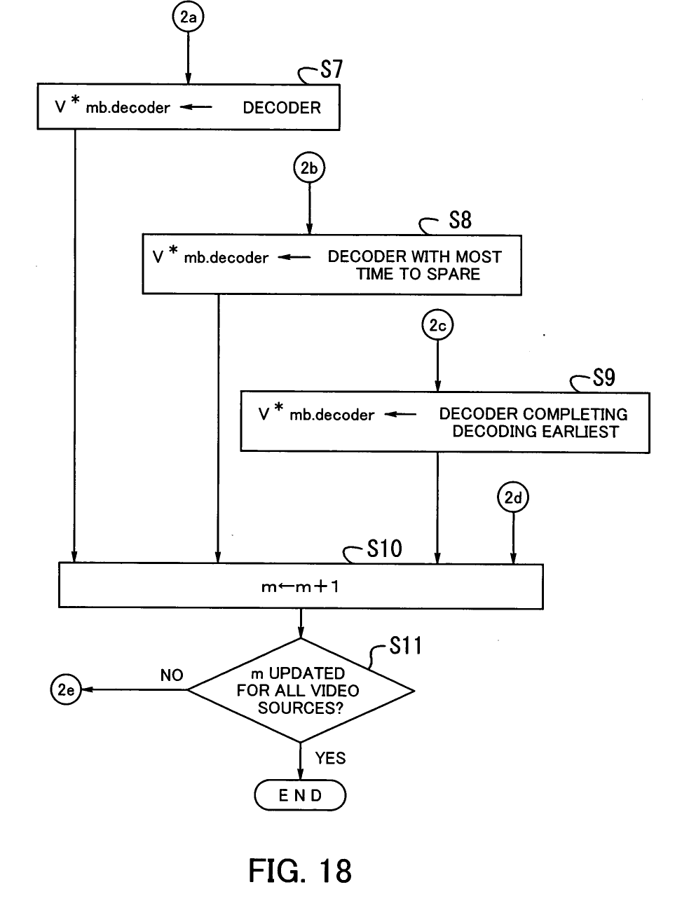

The aforementioned decoder allotment algorithm of the scenario manager 21a will be now described with reference to the flowcharts of FIGS. 17 and 18.

S1: The value m indicative of a video source number is initialized (m←1: in the case of the initial scheduling interval shown in FIG. 5, m starts from “7”).

S2: As a decoder to which the video V*mb is to be allotted, a decoder is searched for to which the video V*ma has been allotted and which fulfills all conditions of Expressions (1a), (1b) and (1c).

S3: If such a decoder fulfilling the conditions of Expressions (1a), (1b) and (1c) exists, the process proceeds to Step S4; if not, the process proceeds to Step S5.

S4: The video V*mb is allotted to the decoder to which the video V*ma has been allotted, whereupon the process proceeds to Step S10.

S5: A decoder(s) are searched for which fulfill the condition of Expression (2) and which are idle at the time V*mb.start.

S6: As a result of the search for a decoder(s) fulfilling the condition of Expression (2), if one decoder is found, the process proceeds to Step S7; if a plurality of decoders are found, the process proceeds to Step S8; if no decoder is found, the process proceeds to Step S9.

S7: The video V*mb is allotted to the corresponding decoder, whereupon the process proceeds to Step S10.

S8: The video V*mb is allotted to a decoder which completes the decoding earliest, among those fulfilling the condition of Expression (2) (since Δs for the initialization process and Δe for the termination process possibly vary depending on the traffic of the network 3, a decoder which completes the decoding earliest and thus have most time to spare is selected), whereupon the process proceeds to Step S10.

S9: The video V*mb is allotted to a decoder which completes the decoding earliest among all decoders.

S10: The value m is updated (m←m+1).

S11: If all video sources falling within the scheduling interval have been allotted to decoders, the process ends; if not, the process returns to Step S2.

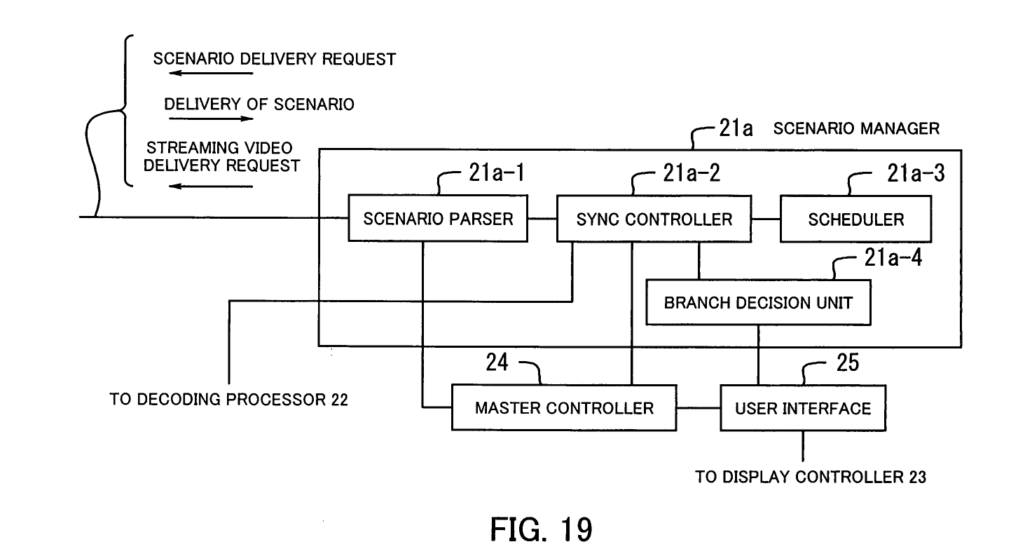

The configuration of the scenario manager 21a will be now described in detail with reference to FIG. 19. The scenario manager 21a comprises a scenario parser 21a-1, a synchronization (sync) controller 21a-2, a scheduler 21a-3, and a branch decision unit 21a-4.

In response to a scenario read instruction, the scenario parser 21a-1 communicates with the contents server 12 to download a corresponding scenario and converts the scenario to internal format (the parser reads in the scenario and expands same into sub-scenarios). The scenario data thus read is set, via the master controller 24, in the synchronization controller 21a-2 as a target of playback.

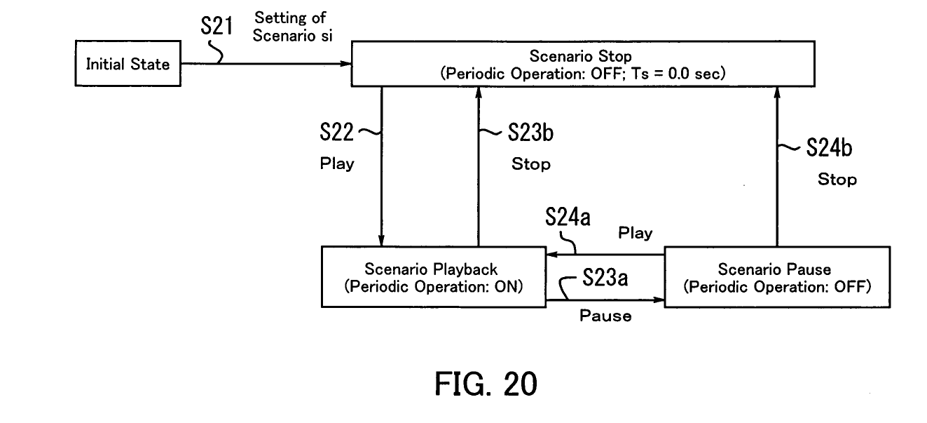

After the scenario is set, the synchronization controller 21a-2 manages synchronization among the decoders 22-1 to 22-n and the scheduler 21a-3. Also, in response to a scenario playback instruction from the master controller 24, the synchronization controller 21a-2 operates periodically at short intervals (e.g., at intervals of several msec). In this case, if scenario pause is instructed, the periodic operation is stopped and also the incrementing of the scenario time is stopped. On the other hand, if scenario stop is instructed, the periodic operation is stopped and also the scenario time is reset to the initial value (0.0 sec) (the state transitions will be described in detail later with reference to FIG. 20).

The scheduler 21a-3 executes the decoder allotment algorithm explained above with reference to the flowcharts of FIGS. 17 and 18. The branch decision unit 21a-4 compares a branching parameter set via the user interface 25 with the branching condition described in the scenario to select a video meeting the condition, and provides a selection instruction to the synchronization controller 21a-2.

When the video playback time reaches the branching time of a sub-scenario being played back (or when a branch is determined before the branching time), the synchronization controller 21a-2 inquires of the branch decision unit 21a-4 about a next branch sub-scenario. The branch decision unit 21a-4 compares the branching parameter specified via the user interface 25 with the branching condition in the sub-scenario and selects the next sub-scenario.

After the next sub-scenario si+1 is selected, the synchronization controller 21a-2 releases the decoder 22 to which the unselected branch video source has been allotted, and also the scheduler 21a-3 allots new video source to the decoder 22.

FIG. 20 illustrates state transitions of the synchronization controller 21a-2.

S21: When a scenario si is set in the initial state, transition to a scenario stop state takes place. In the scenario stop state, the periodic operation is set OFF and the scenario time Ts is set to 0.0 sec (Ts=0.0 sec). The scenario time Ts is time which is incremented with the periodic operation of the synchronization controller 21a-2 and which indicates the time elapsed from the start of playback of the scenario.

S22: If, in the scenario stop state, scenario playback (Play) is instructed from the master controller 24, transition to a scenario playback state (periodic operation: ON) takes place.

S23a: If, in the scenario playback state, scenario pause (Pause) is instructed from the master controller 24, transition to a scenario pause state (periodic operation: OFF) takes place.

S23b: If, in the scenario playback state, scenario stop (Stop) is instructed from the master controller 24, transition to the scenario stop state takes place.

S24a: If, in the scenario pause state, scenario playback (Play) is instructed from the master controller 24, transition to the scenario playback state (periodic operation: ON) takes place.

S24b: If, in the scenario pause state, scenario stop (Stop) is instructed from the master controller 24, transition to the scenario stop state takes place.

The operation of the decoder 22 will be now described. The decoder 22 performs the initialization process, playback process and termination process with respect to the video V*m, and the process to be performed at a current time (in this instance, current scenario time Ts) is determined according to the following Expressions (3a), (3b) and (3c):
Ts<V*m.start (3a)
V*m.start≦Ts<V*m.start+V*m.duration (3b)
V*m.start+V*m.duration≦Ts (3c)

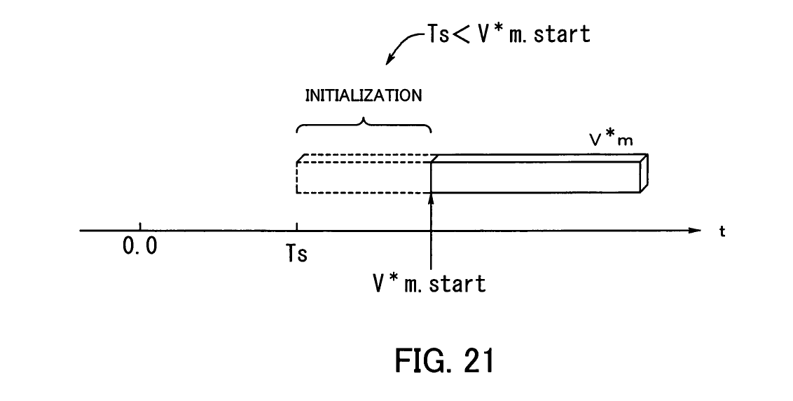

Referring now to FIGS. 21 to 23, what are meant by Expressions (3a), (3b) and (3c) will be explained. FIG. 21 shows a state wherein the initialization process is being performed. Expression (3a) indicates a condition for carrying out the initialization process, and if the current scenario time Ts fulfills Expression (3a) and at the same time the corresponding decoder is at a stop, the initialization process of the video V*m is performed.

Namely, if the video V*m−1 is at a stop, the URL of the video V*m is set and pre-fetching is carried out. Pre-fetching denotes preprocessing (including buffering and initialization) which is performed prior to video playback to bring the video to an instantly playbackable state (after the pre-fetching is carried out, the video is displayed as soon as the switch is depressed by the user).

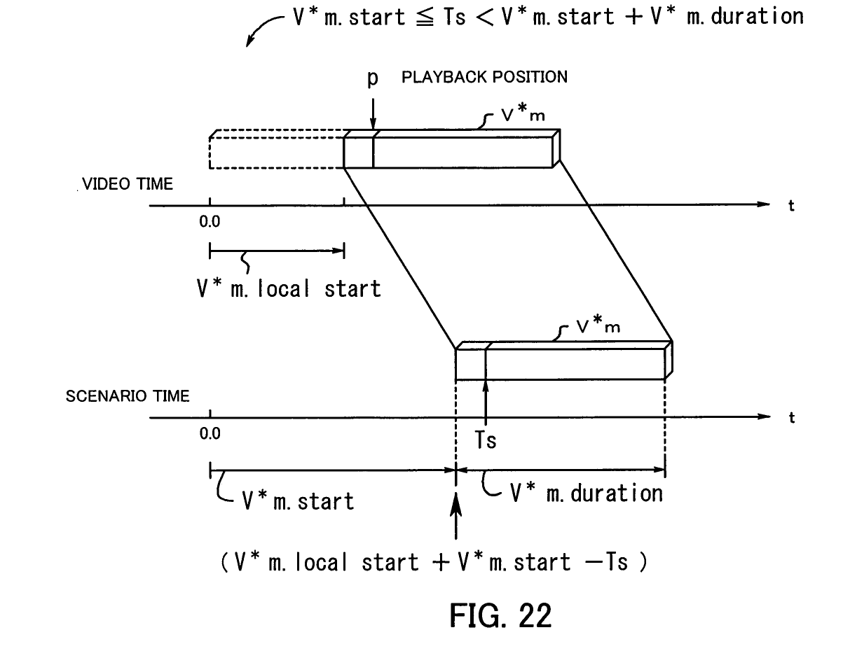

FIG. 22 shows a state wherein the playback process is being performed. Provided a currently playback position in terms of the video time is p and the playback position p corresponds to the scenario time Ts, Ts fulfills the condition specified by Expression (3b). The playback start time of the video V*m in terms of the scenario time is (V*m.local start+V*m.start−Ts) sec.

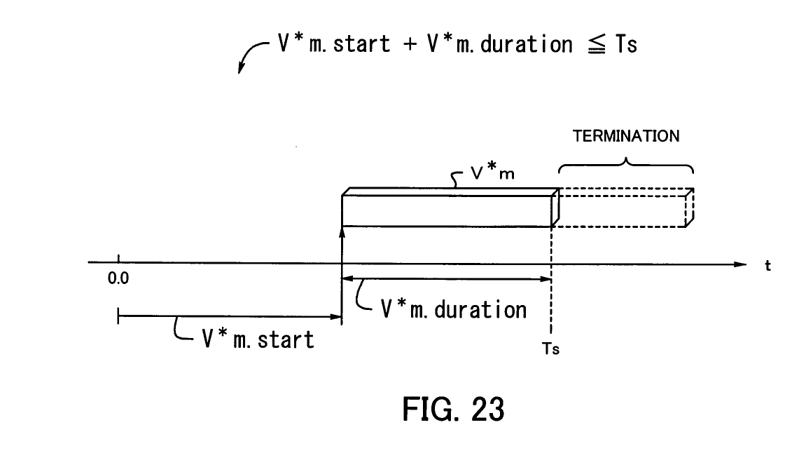

FIG. 23 shows a state wherein the termination process is being performed. Expression (3c) is related with the termination process, and when the current scenario time Ts fulfills Expression (3c), the termination process of the video V*m is carried out. Namely, if the scenario time Ts elapses for V*m.start+V*m.duration during the playback of the video V*m, the playback is immediately terminated (transition to the stop state takes place).

As for Expression (3a), if m=1, that is, if there is no decoder in operation, this condition alone is applied. Also, when the video V*m fulfills Expression (3c) but if there is a video V*m+1 fulfilling Expressions (1a), (1b) and (1c) explained above with reference to FIG. 14, playback of the succeeding video V*m+1 in accordance with the condition of Expression (3b) is preferentially carried out (in the case where the condition for terminating the decoding of the video V*m is satisfied but there is a video V*m+1 continuing from the video V*m, the condition for playing back the video V*m+1 is given priority to the termination condition). Consequently, videos with an identical URL are sequentially played back by the same decoder V*m.decoder (=V*m+1.decoder).

Further, if, after the transition to pre-fetching according to Expression (3a), the condition of Expression (3b) is fulfilled before completion of the pre-fetching (i.e., because of prolonged initialization process, V*m.start is reached before the pre-fetching is completed), the decoder is unable to start playback. In this case, the incrementing of Ts past V*m.start is suspended until the pre-fetching is completed (transition to the video playbackable state takes place), and on completion of the pre-fetching, transition to the video playback state is effected and the incrementing of Ts is restarted (i.e., the playback start time is delayed).

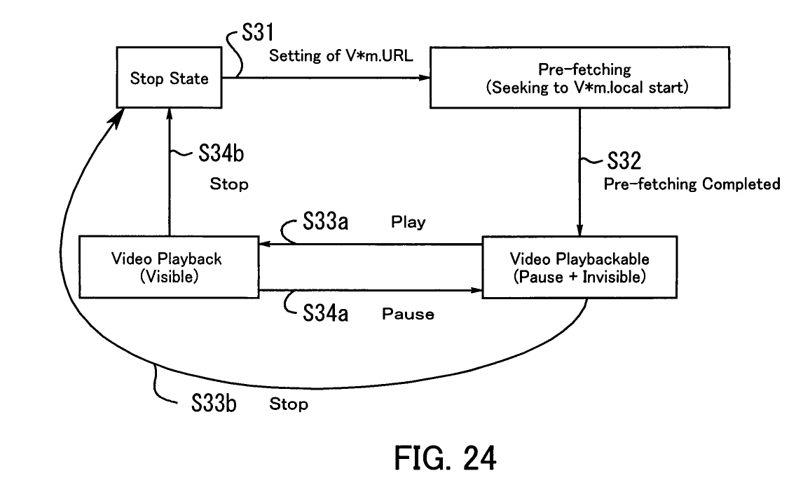

State transitions of the decoder 22 and the display controller 23 will be now described. In the following, the decoder 22 and the display controller 2-3 will be collectively referred to as video player. FIG. 24 illustrates state transitions of the video player.

S31: When the V*m.URL of a video is set in the stop state, transition to the pre-fetching state takes place.

S32: When the pre-fetching is completed in the pre-fetching state, transition to the video playbackable state takes place.

S33a: If video playback (Play) is instructed in the state of video playbackable state (moving picture pause+invisible state), transition to the video playback state takes place.

S33b: If video stop (Stop) is instructed in the video playbackable state, transition to the stop state takes place.

S34a: If video pause (Pause) is instructed in the video playback state (moving picture visible state), transition to the video playbackable state takes place.

S34b: If video stop (Stop) is instructed in the video playback state, transition to the stop state takes place.

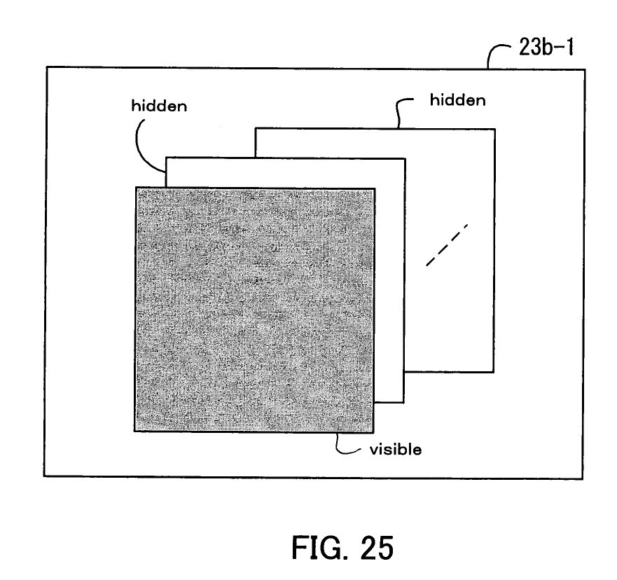

FIG. 25 illustrates visible/invisible switching of the video player. In accordance with the scheduling, the video player previously creates a plurality of video playback screens (media player screens) in an identical region within a screen 23b-1 (in a manner such that the screens are superimposed one upon another).

Each media player screen is made invisible on screen (video playbackable state) by setting its attribute to “hidden”, and is made visible on screen (video playback state) by setting the attribute to “visible”. In this manner, the playback screens are created beforehand and the switching function is performed by changing the attributes between “visible” and “hidden” to display a desired screen.

Thus, according to the present invention, even a plurality of videos which are delivered by streaming and which are to branch out in accordance with the client's instructions can be smoothly and sequentially played back in the order described in the video scenario without the occurrence of a gap at the switchover of neighboring videos.

As described above, in the media playback device of the present invention, a plurality of decoders are scheduled so as to eliminate a time lag between the playback end time of one media and the playback start time of other media, and the playback outputs from the decoders are switched to display the playback media. Thus, even streaming media involving branching playback can be played back without a gap occurring at the switchover of videos, enabling seamless playback of videos.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A media playback device for playing back streaming media, comprising:
a scheduler for scheduling one media and other media to be played back continuously or as a branch media after the one media is played back, so as to eliminate a time lag between a playback end time of the one media and a playback start time of the other media;
a decoding processor including a plurality of decoders for performing decoding processes in parallel with each other to decode respective media allotted by the scheduling; and
a display controller for switching playback outputs from the decoders to display playback media.

2. The media playback device according to claim 1, wherein, provided a branching time is Tb and a time period required for an initialization process of the media is Δs, the scheduler sets a time period (Tb+Δs) as a scheduling interval and treats media included in the scheduling interval as media to be scheduled.

3. The media playback device according to claim 1, wherein, when a branching time is reached or a branch is selected before the branching time, the scheduler releases a decoder to which an unselected branch has been allotted, and re-allots a new branch video to the released decoder.

4. The media playback device according to claim 1, wherein, when allotting a first media and then a second media to the decoders, the scheduler allots the second media to an identical decoder to which the first media has been allotted if entities of the first and second media are stored at an identical location and also if the playback end time of the first media and the playback start time of the second media coincide with each other in terms of media time as well as scenario time.

5. The media playback device according to claim 1, wherein, provided the playback end time of a first media is T, a time period required for a termination process of the first media is Δe, the playback start time of a second media is V*mb.start, and a time period required for an initialization process of the second media is Δs, the scheduler allots the second media to a decoder which fulfills a conditional expression of
(V*mb.start−Δs)≧(T+Δe).

6. The media playback device according to claim 1, wherein, provided a media to be decoded is V*m, a current scenario time is Ts, and the playback start time of the media V*m in terms of the scenario time is V*m.start,
each of the decoders performs an initialization process if a first condition of
Ts<V*m.start
is fulfilled, performs a playback process if a second condition of
V*m.start≦Ts<V*m.start+V*m.duration
is fulfilled, and performs a termination process if a third condition of
V*m.start+V*m.duration≦Ts
is fulfilled.

7. The media playback device according to claim 6, wherein, where there exists a video V*m+1 in which entities of first and second media are stored at an identical location and the playback end time of the first media and the playback start time of the second media coincide with each other in terms of media time as well as the scenario time, playback of the video V*m+1 in accordance with the second condition is preferentially performed by the corresponding decoder even if the third condition is fulfilled.

8. The media playback device according to claim 6, wherein, if, after transition to pre-fetching including the initialization process according to the first condition, the second condition is fulfilled before the pre-fetching is completed, the corresponding decoder suspends incrementing of the scenario time associated with the playback start time until the pre-fetching is completed, and on completion of the pre-fetching, effects a transition to a playback state and restarts the incrementing of the scenario time.
